(19) United States
(12) Patent Application Publication
(10) Pub. No.: US 2008/0266563 A1
(43) Pub. Date: Oct. 30, 2008

(54) Measuring color using color filter arrays

(76) Inventors: David J. Redman, Boise, ID (US); Steve A. Jacob, Boise, ID (US); Randall G. Guay, Meridian, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/789,876

(22) Filed: Apr. 26, 2007

(51) Int. Cl. G01N 21/25

(52) U.S. Cl. 356/406

(57) ABSTRACT

Embodiments including color filter arrays are disclosed.

### INTRODUCTION

Color measurement instruments can be broadly classified as colorimeters, abridged spectrometers, and spectrometers. Apparatuses that measure reflected light are called photometers, e.g., spectrophotometer, whereas apparatuses that measure emitted light are called radiometers, e.g., spectroradiometer.

Some color measuring apparatuses have been proposed that can measure both reflective and emissive objects. However, such apparatuses have to be switched via user input in order to select between reflective and emissive measurements.

### BRIEF DESCRIPTION OF THE DRAWINGS

FIG. 1 illustrates a portable color measuring apparatus embodiment of the present disclosure.

FIG. 2A illustrates a color calibration component for use with a portable color measuring apparatus of the present disclosure.

FIG. 2B illustrates another color calibration component for use with a portable color measuring apparatus of the present disclosure.

FIG. 3 illustrates a representation of a color filter array having a number filters formed with materials having different color characteristics according to an embodiment of the present disclosure.

FIG. 4A illustrates a monitor attachment component for use with a portable color measuring apparatus of the present disclosure.

FIG. 4B illustrates another monitor attachment component for use with a portable color measuring apparatus of the present disclosure.

FIG. 4C illustrates a view of the monitor attachment component of FIG. 4B taken along line 4C-4C.

FIG. 5A illustrates a representation of a set of example light transmission curves for an eight color filter array.

FIG. 5B illustrates representation of another set of example light transmission curves for an eight color filter array.

FIG. 6 illustrates a representation of light sources emitting light with differing intensities across a visible color spectrum according to an embodiment of the present disclosure.

FIG. 7 is a block diagram illustrating a method of measuring color according to an embodiment of the present disclosure.

### DETAILED DESCRIPTION

Embodiments of the present disclosure include systems, apparatuses, and methods for providing abridged spectrophotometers and/or spectroradiometers. For example, in some embodiments through use of a larger number of color channels, e.g., greater than about 6 or 8, it is possible to reconstruct or estimate the original spectral content of a measured color for reflective objects. The present disclosure includes embodiments that describe the use of CFA's with 5 or more color channels to create such apparatuses.

In general, spectrometers are more color accurate than abridged spectrometers which are in turn more color accurate than colorimeters. This is often due to a decreasing number of color channels as apparatuses proceed from full spectrometers to calorimeters.

The number of color channels can be associated with sampling theory. The more color channels, the finer the sampling of a light spectrum associated with a particular color.

Colorimeters may have 34 color channels, abridged spectrometers may have 5-16 channels whereas spectrometers may have 17 or more channels. The number of channels associated with a particular classification of instrument is somewhat flexible, particularly between abridged and full spectrometers.

Typically, the signal associated with a color channel arises from the collection of light energy from a range of continuous wavelengths. For example, the light energy passing through a color filter that transmits wavelengths from a range such as 380-500 nm onto an electronic sensor that generates a signal, can be called the ‘Blue’ channel signal. To create a color channel, light has to be separated into multiple ranges of wavelengths.

Most instruments are based on a small set of light-separation technologies. These technologies include: (1) diffraction gratings; (2) interference filters; (3) color filter arrays; and (4) Light Emitting Diode (LED) based designs.

Technologies 1-3 separate light into ranges of wavelengths which then falls on multiple sensors to generate a simultaneous set of signals. LED-based designs use a monochromatic sensor and a series of different colored LED's which are turned on one-at-a-time to generate a sequence of signals. Color filter arrays (CFA's) have used 3-4 color channels which are found in calorimeters.

The visible spectrum can be defined as light with wavelengths approximately between 400-700 nm. For example, the wavelength range of 380-730 nm, can be considered the visible spectrum for many applications, which constitutes a range of 350 nm (i.e., 730 nm minus 380 nm).

Some color capture apparatuses that have been proposed, such as some digital cameras, use 3 filters to separate the incoming visible light into 3 channels of color information. Most digital cameras that use on-chip Color Filter Arrays (CFA) have RGB (red, green, and blue) transmissive color filters, while some use CMY filters (cyan, magenta, and yellow). Such filters have transmission curves which are relatively broadband having widths of about 150 nm or so (e.g., usually a little larger than 350/3≈117).

When using these filters, the spectrum of a particular color passes through the filters and onto a number of sensors which create signals proportional to the total light energy passing through each filter. For example, if a blue (B) filter allows light from 380-560 nm to be transmitted to the sensor beyond the filter, the total light energy transmitted through the filter is integrated by the sensor to produce a single B signal or value. The same is true for the R and G filters. Consequently, the spectrum of any impinging color produces 3 channels of color information, 3 signals associated with the R, G, and B filters.

Unfortunately, in such systems, it is possible for two colors with different spectra to produce the same RGB values. This phenomenon is often referred to as instrument metamerism (e.g., multiple colors producing the same instrument reading).

This is possible for the B channel, for example, since the light spectra in the 380-560 nm range may be different on a wavelength-by-wavelength basis, but may integrate across the B wavelength range to generate the same B value at the sensor. For instance, color X might have more light energy at 423 nm while color Y might have more energy at 516 nm.

However, if the total light energy transmitted through the B filter to the B sensor is the same, the B values will be the same and, hence, indistinguishable from the standpoint of the B signal. If this is true for the R and G signal, as well, then RGB_{A}=RGB_{B}. Consequently, color A and color B can be indistinguishable to the instrument even though the two colors may appear very different to the human observer.

One way to reduce instrument metamerism and/or improve color accuracy in general is to use more than 3 channels of color information. In general, more color channels can result in higher color accuracy, in many systems.

Highly accurate instruments might be obtained using 35 or even 70 channels whereas less accurate instruments might be obtained using 6-12. However, the law of diminishing returns is generally at work in such implementations. That is, 70 channels may not be twice as accurate as 35 channels.

For certain color measurement work, 6-12 channels can be used to produce acceptable color accuracy. Such additional channels of color information can be created with additional filters (e.g., 8 color channels can be accomplished by 8 color filters).

There are several methods of creating additional filters. For example, with on-chip CFA's, existing RGBCMY filters may be combined in several ways.

Labor and material costs can be reduced by combining materials with different color transmittance characteristics. For example, as described below, combining a material used in a filter having a blue (B) transmittance intensity peak with a material used in a filter having a magenta (M) transmittance intensity peak can result in a color filter having a transmittance wavelength peak intensity different from either a B or M color filter.

As such, a combined B-M color filter, for example, can be used in addition to, or instead of, another color filter to contribute to forming a color filter array (CFA). A C-M filter might be combined by mixing C and M colorants together before on-chip deposition or by stacking C and M filters on top of each other, one after the other.

Accordingly, among various embodiments of the present disclosure, a color measuring apparatus can detect a color spectrum of an object using a number of color filters, where a number of materials each having a different color spectral characteristic are used to form an array of color filters transiting at least five portions of the color spectrum. The color measuring apparatus can utilize at least one color filter that is a combination of at least two of the number of materials having a different color spectral characteristic.

In some embodiments, a color measuring apparatus can include, a color filter array having a number of filters thereon, where the number of filters transit light to a number of sensors of a sensing circuit in a portable color measuring apparatus. The apparatus can include one or more memory locations having a number of sets of instructions executable by a processing circuit.

The memory can include instructions, for example, to select initiation of one or more sets of instructions for reflective color measuring and a set of instructions for emissive color measuring. In such embodiments, the one of the sets of reflective color measuring and emissive color measuring instructions utilize a number of specialized components that is not utilized by the other set of instructions. In such embodiments, it may be that some components are utilized by both sets, but one or more components (such as a light source) are not.

The memory can also include a number of other types of instructions. For example, the memory can include instructions to determine whether a measurement is to be taken utilizing the reflective or emissive color measuring instructions based upon data from the color sensor itself or one or more additional sensors.

In some embodiments, the memory can include instructions to determine whether sensor data taken from one or more sensors is reflective or emissive color data. The memory can include instructions to determine whether sensor data was taken utilizing reflective or emissive color measuring instructions.

The memory can include instructions to take a first measurement with an internal illuminant in an ON state, and to switch the illuminant to an OFF state to take a second measurement. In some embodiments, the apparatus can include an operator interface where an operator may select the first or second measurement.

Such selection can also be accomplished via executable instructions in memory provided in software or firmware. Instructions can also be provided to indicate to the operator a type of measurement that one or more of the first or second measurements is.

In some embodiments, the apparatus can include an orientation sensor and instructions to interpret orientation sensor data to determine whether a target is emissive or reflective. In such embodiments, the apparatus can include an orientation sensor and instructions to interpret orientation sensor data to determine a type of measurement that is to be performed by the apparatus.

The present disclosure also includes a number of system embodiments, for example, in some embodiments a portable color measuring system can include a color filter array having a number of filters thereon, where the number of filters transit light to a number of sensors of a sensing circuit in a portable color measuring apparatus, a sensing means for sensing whether a target to be measured is a reflective or emissive light source, and a processing circuit for processing instructions. The instructions to be processed can, for example, include instructions to interpret data from the sensing mechanism and select initiation of a set of instructions for reflective color measuring or a set of instructions for emissive color measuring based upon the interpretation of the data. In such embodiments, the system can include one of the sets of reflective color measuring or emissive color measuring instructions utilizing a number of specialized components (e.g., a light-emitting diode) that is not utilized by the other set of instructions.

In some embodiments, the specialized components utilized by the reflective color measuring instructions can include multiple light sources (e.g., light-emitting diodes) each having different color characteristics. In some such embodiments, the combination of emitted light from the multiple light sources substantially covers a visible color spectrum.

Some embodiments can be designed to with components that can facilitate communicating to a remote location using a wireless connection. Such components can include one or more transmitters, transceivers, and/or antennas, among other items. System embodiments can also include one or more of the following components which provide additional functionality to the system. Such functions and components include a mechanism to record the light color spectrum measurement and/or the information associated with the object being measured on a storage medium that is removable, a spot locator, a strip guide, a cathode ray tube holder, a liquid crystal display holder, and/or at least one calibration reference sample, where a group of calibration reference samples includes a white sample, a black sample, and/or a gray sample.

The present disclosure also includes a number of method embodiments. For example, in some embodiments, the method can include detecting a color spectrum of an object using a number of color filters.

In such embodiments, a number of materials each having a different color spectral characteristic can be used to form an array of color filters transiting at least five portions of the color spectrum. Embodiments can also include selecting initiation of one or more sets of instructions for reflective color measuring and a set of instructions for emissive color measuring that each utilize at least one color filter that is a combination of at least two of the number of materials.

In some embodiments, the method can include taking a measurement with the internal illuminant in an off state and analyzing the measurement to determine if there is an amount of light energy over a threshold amount. Embodiments can also include taking a first measurement with the internal illuminant in a first state, taking a second measurement with the internal illuminant in a second state, and analyzing the first and second measurements to determine if there is a difference between amounts of light energy of the first and second measurements that is over a threshold amount. For example, the first state can be an off state and the second state can be an on state, or in some embodiments, the first state can be a high state and the second state can be a low state.

In some embodiments, if the analysis of the first and second measurements to determine if there is a difference between amounts of light energy of the first and second measurements that is over a threshold amount indicates that the difference is over the threshold, then a target can be determined to be reflective. Accordingly, in some embodiments, if the analysis of the first and second measurements to determine if there is a difference between amounts of light energy of the first and second measurements that is over a threshold amount indicates that the difference is not over the threshold, then a target can be determined to be emissive. Other such threshold based determinations can be made based upon the sensor data and/or calculations thereof, such as the difference.

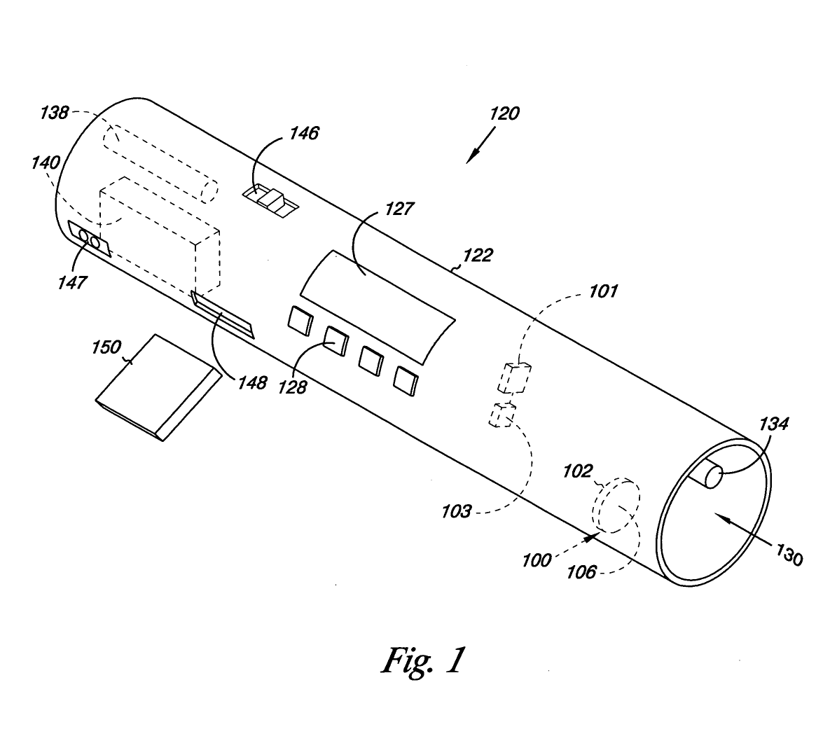

FIG. 1 illustrates an example portable color measuring apparatus suitable to implement embodiments of the present disclosure. The embodiment of the portable color measuring apparatus 120 shown in FIG. 1 can be used for measuring intensities of portions of a color spectrum of light reflected by an object and/or light emitted by an object.

As such, as will be appreciated by one of ordinary skill in the relevant art, the portable color measuring apparatus 120 can function as a spectrophotometer by measuring color reflected from an object and/or function as a spectroradiometer by measuring color emitted by the object. In some embodiments, the color measuring apparatus can be designed to determine the type of light to be analyzed (reflected/emitted) and can, therefore, switch between two mechanisms for measuring the light. This switching functionality can be accomplished automatically, in some embodiments, such as through use of executable instructions, and/or can be done through operator input.

To provide color measuring functionality, embodiments of the present disclosure include executable instructions stored in memory and executable by a processing circuit. For example, in the embodiment of FIG. 1, the apparatus 120 includes a processor 101 and memory 103. The processing circuit (e.g., processor) can be any suitable type of processing circuitry and the memory can be any suitable type of fixed or removable memory and memory is to be interpreted as including instructions stored in the form of firmware or software.

The memory can include instructions, for example, to select initiation of one or more sets of instructions for reflective color measuring and/or a set of instructions for emissive color measuring. In such embodiments, the one of the sets of reflective color measuring and emissive color measuring instructions utilize a number of specialized components that is not utilized by the other set of instructions. In such embodiments, it may be that some components are utilized by both sets, but one or more components (such as a light source) are not.

The memory can also include a number of other types of instructions. For example, the memory can include instructions to determine whether a measurement is to be taken utilizing the reflective or emissive color measuring instructions based upon data from one or more sensors.

In some embodiments, the memory can include instructions to determine whether sensor data taken from one or more sensors (e.g., sensor 106) is reflective or emissive color data. The memory can include instructions to determine whether sensor data was taken utilizing reflective or emissive color measuring instructions.

The memory can include instructions to take a first measurement with an internal illuminant in an on state, and to switch the illuminant to an off state to take a second measurement. In some embodiments, the apparatus can include an operator interface where an operator may select the first or second measurement.

Such selection can also be accomplished via executable instructions in memory provided by software or firmware. Instructions can also be provided to indicate to the operator a type of measurement that one or more of the first or second measurements is.

The color measuring apparatus embodiment 120 of FIG. 1 can include a color imaging functionality that can, for example, measure color intensities in an image to be reproduced. In some embodiments, color measuring apparatuses, such as apparatus 120, can use a color measuring component that implements CFA sensors as described below, among other sensor types.

In some embodiments, the color intensity values measured by the CFA sensors can be stored for image reproduction at a time determined by a user. By way of example and not by way of limitation, color measuring apparatus embodiments that utilize embodiments of color measuring components of the present disclosure can be used with color imaging apparatuses which include, for example, printers (e.g., inkjet, laser, etc.), scanners, facsimile (fax) machines, and/or digital cameras, among others.

For instance, by way of example and not by way of limitation, a portable color measuring apparatus can be used for measuring a color gamut of light being emitted while displaying an image on a display (e.g., a color monitor connected to a computing apparatus and/or a high definition digital television screen). Such sensing apparatus embodiments also can, for example, be used for measuring colors of reflected light associated with art work displayed in a museum, measuring light associated with an object of nature, and/or recording color images of the previously mentioned objects, for example, through implementation in a digital camera.

The embodiment of the portable color measuring apparatus 120 shown in FIG. 1 includes a housing 122 that can house or be associated with some or all of the elements described in embodiments of the present disclosure. The housing can include a number of buttons, switches, and/or other user input mechanisms that can be used to provide operator interface functionality. For example, the housing of the portable color measuring apparatus 120 can include a menu button and an escape button to provide an operator interface for control over (e.g., selection/deletion) information and/or functions shown in a display window 127.

An operator interface of the present disclosure can, among other uses, be used to control an application software package can being utilized and/or to enter information associated with an object being measured. For example, an operator interface can include a display window that can have one or more functions. For example, a display window can allow the user to access the light color spectrum measurement in real time.

In some embodiments, a display window can allow access to the information associated with the object being measured as the information is being entered. Additionally, a display window can allow access to a stored light color spectrum measurement and/or stored information associated with a measured object.

In some embodiments, a display window can present a menu(s) (e.g., in a multilevel format) that allows a user access to functions and/or information accessible to the portable color measuring apparatus. Presentation of the functions and/or information to the user in a display window can, in some embodiments, be performed using a digital graphics display (e.g., LCD). In some embodiments, the display window can be a touch screen that can allow a user to input commands or selections by touch the screen with their finger or a stylus, for example.

In some embodiments, the apparatus may be capable of automatically detecting whether or not a reflective or emissive measurement is being made and turn on or turn off an illumination source autonomously. One way this can be accomplished is by taking a reading with and without the internal illuminant turned on and determining the nature of the signal based upon the difference in the readings.

Another way to accomplish this can be to automatically determine the orientation of the apparatus. For instance, spectrophotometric measurements are usually made with the reflective media lying flat (e.g., printer profiling) whereas spectroradiometric measurements are typically made with the emissive media vertical (e.g., computer monitor profiling).

One or more sensors can be used to provide an indication of the orientation of the apparatus. For instance an orientation sensor, such as a gravity sensor, magnetic sensor, or the like, can be used to determine whether the apparatus is oriented generally vertically or horizontally.

In various embodiments, the housing 122 of the portable color measuring apparatus 120 shown in FIG. 1 can include a number of buttons 128 to provide a user interface for selection of various items or to provide functionality to the user interface. For example, the buttons can be used to select from a number of various programs that, when executed, can, for example, control measurement of color in an object being examined.

For instance, some embodiments can be designed such that an operator could input a selection of a type of measurement to be made (e.g., reflective or emissive). A mechanism is described below to provide the portable color measuring apparatus 120 with the various programs from which choices can be made through the user interface.

As shown in FIG. 1, the housing 122 of the portable color measuring apparatus 120 can be configured, in various embodiments, to include a light input aperture 130. The light input aperture 130 can allow light reflected from and/or emitted by an object being measured to directly or indirectly reach at least one CFA associated with sensors and circuitry enabling measurement of intensities of portions of a color spectrum of interest to a user as described in embodiments of the present disclosure. The light input aperture can be of any suitable type and/or shape.

In some embodiments, as illustrated in FIG. 1, the housing 122 can be configured to include one or more light output components. The light output component can allow a light source (e.g., a light-emitting diode) 134 to illuminate an object to facilitate measurement of intensities of portions of a color spectrum of interest to a user by enhancing available light to be reflected from the object being measured.

As described below, various types and numbers of light sources can be utilized individually and/or in combination to illuminate the object being measured with light having characteristics (e.g., a particular spectral range of wavelengths, a particular intensity of wavelengths in a portion of a spectral range, etc.) of interest to a user. The portable color measuring system can include, in some embodiments, a light-emitting diode for illumination of an object to be measured. In various embodiments, such as described below, a system can include at least two light-emitting diodes each having different color characteristics, where a combination of emitted light substantially covers a visible color spectrum.

The light input aperture and the light output component are illustrated in FIG. 1 as being positioned proximate to each other on one end of the apparatus 120, however, the placement of the light input aperture 130 and the light output component 134 can be configured, in various arrangements. Additionally, a light input aperture for CFA sensors and a light output aperture for a light source can be separable from a single housing or included in separate housings.

In some embodiments, the portable color measuring apparatus 120 illustrated in FIG. 1 can be utilized as a component of a system for conveying information to a remote location (e.g., using a wired connection, a wireless connection, a removable information storage medium, and/or other ways of conveying information to a remote location) related to intensities of portions of a color spectrum detected by the portable color measuring apparatus 120. At the remote location, the sensed light information can, for example, be used by processing circuitry to enable execution of functions by an associated system apparatus (e.g., a personal computer, a printer, etc).

In various embodiments, the portable color measuring apparatus can include a mechanism for communicating an intensity of light sensed by the sensing circuit to a remote location. The mechanism for communicating to the remote location can include a wireless connection and/or a wired connection, for example, as described below.

In such embodiments, the housing 122 of the portable color measuring apparatus 120 can, for example, include a structure for an antenna 138 that can provide wireless communication with a component of the system at the remote location. In some embodiments one or more transmitters and/or transceivers can be used. The placement of the antenna 138 on the portable color measuring apparatus 120 is chosen for ease of illustration and not by way of limitation.

Accordingly, the portable color measuring system can include, in various embodiments, a processing circuit at the remote location for interpreting an intensity of a sensed portion of a light color spectrum as a measurement thereof. Measurements of the sensed portion of the light color spectrum can be stored in association with information related to a measured object.

A portable color measuring system can include a CFA 100 having a number of filters thereon, where the number of filters transit light to a number of sensors of a sensing circuit in a portable color measuring apparatus. In the embodiment of FIG. 1, a CFA 100 includes circuitry 102 (e.g., a circuit board) that can be connected to a processing circuit. The circuitry 102 of the CFA 100 embodiment can be associated with a number of sensors (e.g., photodiodes) that can enable registering of an intensity of light being sensed.

By way of example and not by way of limitation, each sensor of the CFA 100 can be associated with at least one color filter 106. Although only one CFA, one circuit, and one filter are illustrated in FIG. 1, various embodiments can include multiple CFAs, circuits, and/or color filters.

The embodiment of the portable color measuring apparatus 120 illustrated in FIG. 1 includes a power source component 140. The power source component 140 can house a supply of electrical energy that enables operation of various electrically powered functions in the portable color measuring apparatus 120 when the apparatus is unconnected to another source of electrical energy (e.g., an alternating current wall outlet). By way of example and not by way of limitation, the power source component 140 can house various types of power sources (e.g., one or more disposable/replaceable batteries, rechargeable batteries, manual induction coils, and/or fuel cells, among other types).

As illustrated in the embodiment of the portable color measuring apparatus 120 shown in FIG. 1, the apparatus can include a power switch button or other user actuatable mechanism. In some embodiments, the device can include a proximity sensor and can power up when positioned within proximity to an object to be targeted. In the embodiment of FIG. 1, the power switch 146 can, for example, control whether electrically powered functions in and/or associated with the housing 122 can be supplied with electrical energy by the power source component 140.

As shown in FIG. 1, in some embodiments, the portable color measuring apparatus 120 can include a connector 147. The connector 147 can, in various embodiments, enable the portable color measuring apparatus 120 to communicate with outside processing circuitry (e.g., at a remote location) using a wired connection. The connector 147 can serve as an electrical energy input to enable operation of the portable color measuring apparatus 120 and/or to enable recharging of a rechargeable power source component 140.

In some embodiments, wireless and/or wired connection of the portable color measuring apparatus 120 to a remote location can be accomplished through use of a docking station (not shown) that can allow a saved intensity of the light sensed by a sensing circuit to be communicated to the remote location, where the connector 147 can serve to link the portable color measuring apparatus 120 to the docking station. A docking station can, in some embodiments, enable input through the connector 147 of information and/or executable instructions obtained from the remote location through wireless communication or otherwise.

In some embodiments of the present disclosure, a portable color measuring apparatus can include its own processing circuit for interpreting the intensity of a sensed portion of the light color spectrum as a measurement thereof. A portable color measuring apparatus can include internal memory storage for the light color spectrum measurement and/or information associated with the object being measured. In some embodiments, a portable color measuring apparatus can include a mechanism to calibrate its processing circuit (e.g., by using a calibration reference sample).

As illustrated in the embodiment of the portable color measuring apparatus 120 shown in FIG. 1, the apparatus can include an input port 148 that, among other functions, can receive a storage medium 150 (e.g., a flash memory card) on which additional embodiments of executable instructions are stored (e.g., an application software package(s) for interpreting intensities of sensed portions of a color spectrum as measurements thereof). Instructions that can be provided to the portable sensing apparatus can include, for example, instructions for executing color matching, match prediction, batch correction, tinting strength calculations, shade sorting, and other functions.

In various embodiments, the input port 148 shown in FIG. 1 can be used with the portable color measuring apparatus 120 to enable recording a light color spectrum measurement and/or information associated with an object being measured on a storage medium (e.g., a flash memory card) that can be inserted and removed from the input port 148. Recording information on a storage medium and/or accessing information recorded on a storage medium can be performed by a portable color measuring apparatus using various techniques.

In various embodiments of the portable color measuring apparatus 120 shown in FIG. 1, the apparatus can include an integral spot locator, a strip guide, a cathode ray tube (CRT) holder, and/or a liquid crystal display (LCD) holder. In some embodiments, the portable color measuring apparatus 120 can include at least one calibration reference sample, where a group of calibration reference samples includes a white sample, a black sample, and/or a gray sample. In various embodiments, the calibration reference sample(s) can be positioned inside and/or outside the housing of the portable color measuring apparatus for calibration thereof.

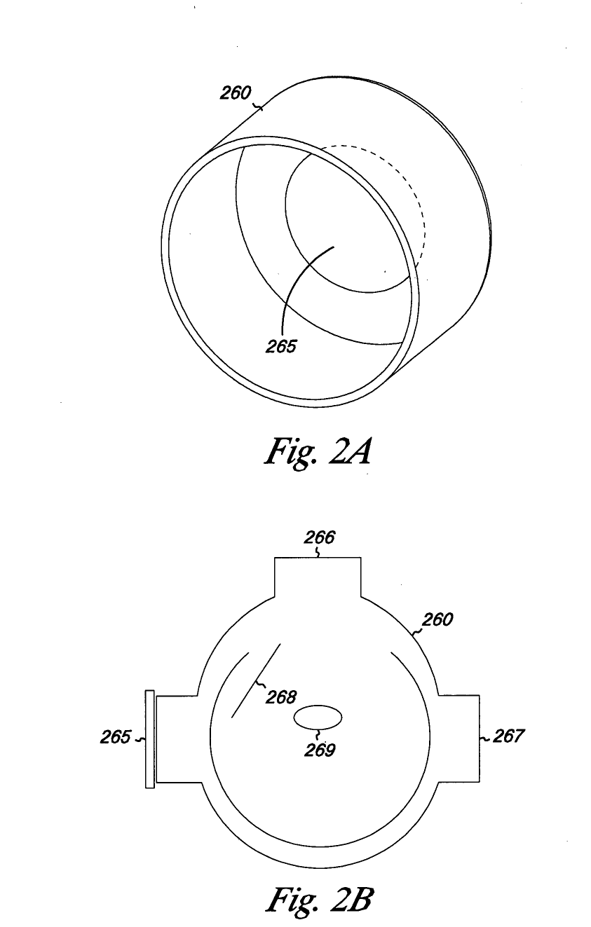

FIG. 2A illustrates a color calibration component for use with a portable color measuring apparatus of the present disclosure. Color calibration components can be provided in various forms and can be provided on the device or off of the device. Although two on device mechanisms are illustrated herein in FIGS. 2A and 2B, other alternative mechanisms can be utilized within the scope of one or more embodiments of the present disclosure.

In the embodiment of FIG. 2A, the calibration mechanism is an end cap 260. The end cap can be mounted on the end of the device (e.g., end that includes light source 134 and light input 130 in the embodiment of FIG. 1). In such an embodiment, a white reference, or other reference type, can be provided on the end cap. In such embodiments, when the light source shines on the white reference, the device can be calibrated to a known reference and, therefore, can take more accurate color measurements, in some instances.

FIG. 2B illustrates another color calibration component for use with a portable color measuring apparatus of the present disclosure. In the embodiment of FIG. 2B, the mechanism is an end cap 260 having a mirror 268 for directing light from a light source toward one of a number of reference components (e.g., references 265, 266, and 267 of FIG. 2B). An alternate embodiment would be to rotate the light source (not shown) and sensor 269 instead of the mirror 268.

In the embodiment of FIG. 2B, the reference 265 is a white reference, the reference 266 is a reflectance aperture, and the reference 267 is a radiometric aperture. In some embodiments, the mirror 268 can be fixed and the reference and apertures 265, 266, and 267 can be moved (e.g., rotated) to align each with the mirror 268. Additionally, in some embodiments, the mirror 268 can move (e.g., rotate) and the reference and apertures 265, 266, and 267 can be fixed.

In some such embodiments, the end cap can be designed such that the aperture opens and closes (e.g., by rotation of one or more end cap components). In this way, a reference (e.g., a white reference) can be provided within the end cap and can be used while the one or more apertures are open and/or closed. Such an arrangement can allow for various different calibrations to be taken.

Detecting which aperture or reference is selected can be used to determine the type of color measurement is to be taken. For example, in some embodiments, the type of calibration selected or being made can be used to indicate to the device what type of measurement is to be taken and the device can switch, for example from reflective to emissive based upon the orientation of the endcap.

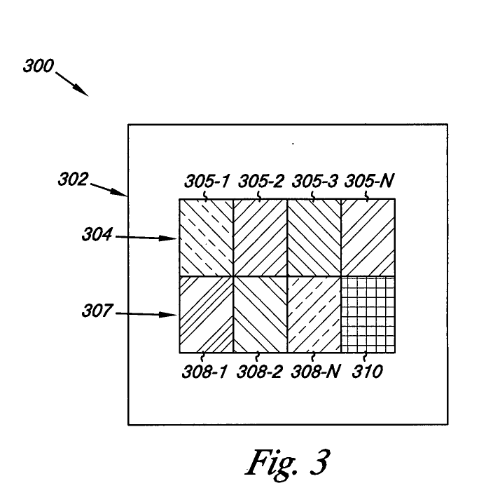

FIG. 3 illustrates a representation of a color filter array having a number filters formed with materials having different color characteristics according to an embodiment of the present disclosure. FIG. 3 illustrates a representation of an embodiment of a CFA 300 that includes an arrangement of eight (8) different color filters each having a different color spectrum transiting characteristic that are used to form an array of color filters.

The CFA 300 shown in FIG. 3 can represent various types of CFAs. As such, the number of filter colors shown, the placement of the filter colors in the array, and the proportion of one color filter to another color filter are illustrated by way of example and not by way of limitation. For example, the CFA 300 has two (2) rows of color filters and four (4) columns of color filters, thereby yielding a total of eight (8) color filters. However, CFAs of the present disclosure can include five or more color filters positioned in any configuration for detecting a color spectrum of an object.

Embodiments of the present disclosure include a number of materials each having a different color spectral characteristic that, for example, can be used to form an array of color filters transiting at least five portions of the color spectrum. For example, five materials each having a different color spectral characteristic can be used to form five different color filters that transit portions of a color spectrum having five different peak intensities.

In some embodiments of the present disclosure, a fifth given color filter can be formed using a combination of two or more materials that includes a combination of materials at least one of which is not used in any of the other color filters. Moreover, in various embodiments, one or more of the color filters that can be used in an array of color filters transiting at least five portions of the color spectrum can be formed using a combination of at least two materials each having a different color spectral characteristic.

In the embodiment of the CFA 300 shown in FIG. 3, the array of color filters can be positioned in association with circuitry 302 for sensing an intensity of a portion of the color spectrum transiting each associated color filter. Some embodiments of CFA 300, by way of example and not by way of limitation, can include a first row 304 that includes a number of color filters 305-1, 305-2, 305-3, . . . 305-N that can use a number of materials each having a different color spectral characteristic to form different color filters that transit portions of a color spectrum having different peak intensities.

The embodiment of the CFA 300 can include a second row 307 that includes a number of color filters 308-1, 308-2, . . . 308-N that, in some embodiments, can use a number of materials each having a different color spectral characteristic to form different color filters that transit portions of a color spectrum having different peak intensities. In some embodiments, each of the examples of color filters (i.e., 305-1, 305-2, 305-3, . . . 305-N) in the first row 304 can use materials having a color spectral characteristic that is different from color spectral characteristics of each of the example color filters (308-1, 308-2, . . . 308-N) in the second row 307.

As illustrated in the embodiment of CFA 300 shown in FIG. 3, by way of example and not by way of limitation, the second row 307 of the CFA 300 can include a color filter 310 that is a combination of at least two of the number of materials, as described above. The CFA 300 can represent various embodiments of CFAs that can be included in various embodiments of color measuring apparatuses where each of the at least two materials can have a different color spectral characteristic.

Such CFA embodiments can include a number of sensing circuits for sensing light transiting at least one of the filters, where each of the filters is associated with at least one sensing circuit. The CFAs can be further associated with a processing circuit to interpret the color spectral characteristics of the sensed light as at least five color channels, where the number of filters used can enable the color measuring apparatus to measure the color channels as spaced in a color spectrum.

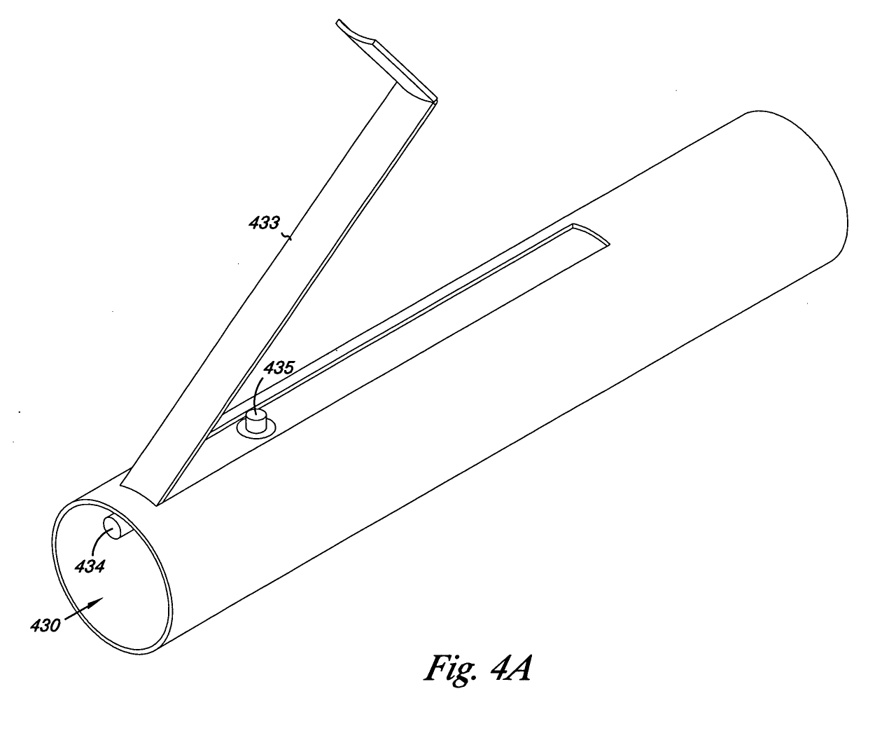

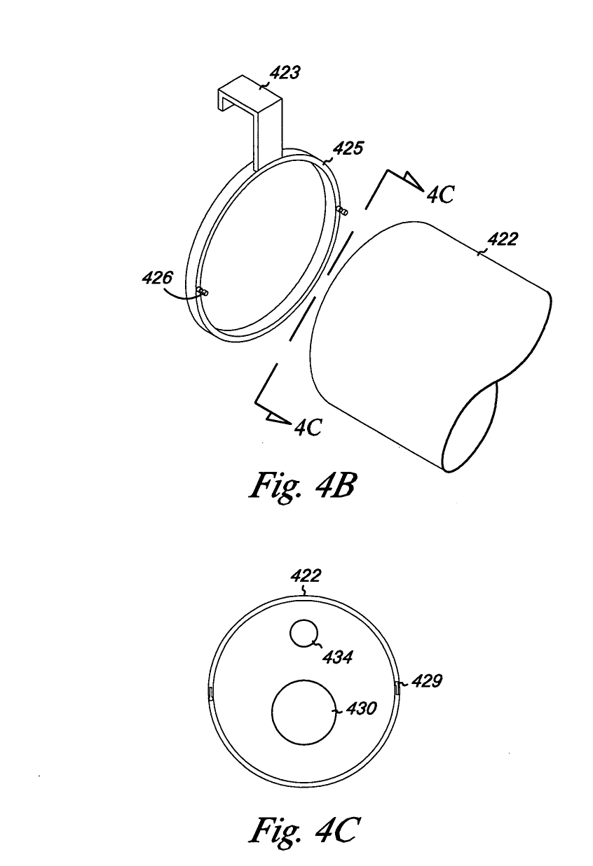

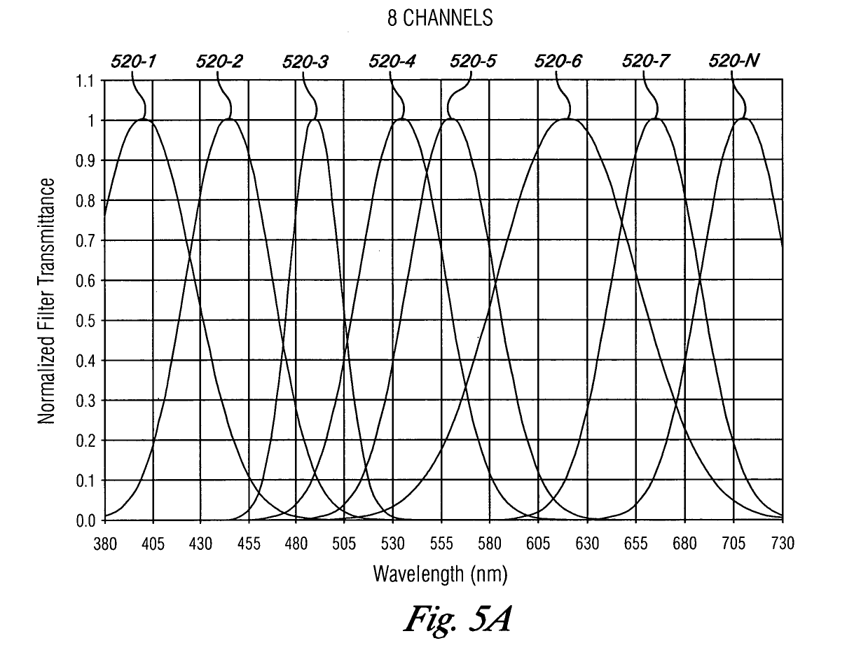

FIGS. 4A-4C illustrates mechanisms for switching the device between a reflective and an emissive measuring configuration. For example, FIG. 4A illustrates a monitor attachment component for use with a portable color measuring apparatus of the present disclosure. In the embodiment of FIG. 4A, the device includes an arm 433 and a button 435.

In such an embodiment, the arm 433, can be used to mount the device against an emissive item to be measured, such as a monitor (not shown) or the like, such that the end of the device having the light source 434 and the light input 430 are proximate to (e.g., near or against) the surface of the emissive item to be measured. For example, the arm 433 can be designed as a hanger or mounting bracket among other mechanisms for positioning the device near the item to be measured.

When the arm 433 is extended, the button 435 is actuated and the actuation indicates that the device is to be used for measuring an emissive item. One of ordinary skill in the art will understand that there a various other orientations of components can type of mechanisms that can be used to indicate that the device is to be placed in proximity to an emissive item to take a measurement and to switch the mode of the device between emissive and reflective functionality.

FIG. 4B illustrates another monitor attachment component for use with a portable color measuring apparatus of the present disclosure. In the embodiment of FIG. 4B, the device housing 422 is mounted to a hanger 425 having an emissive item mount 423 and a device mount 426.

This mechanism is similar to that of FIG. 4A in that the coupling of the device housing 422 with the hanger 425 can be utilized to signal the switching of the device between emissive and reflective measurement functionality. In some embodiments, this switching can be automatic to enable the device to be more quickly and effectively utilized.

FIG. 4C illustrates a view of the monitor attachment component of FIG. 4B taken along line 4C-4C. In the embodiment of FIGS. 4B and 4C, the signaling of the coupling can be provided by the coupling of hangers 426 with apertures 429 (e.g., shown here provided around the end of the device housing the light source 434 and light input 430 of the device housing 422). For example, a sensor can be positioned to sense the coupling of the device mounts 426 with the apertures 429 in the housing 422. The information from the sensor can be used to switch the functionality of the device.

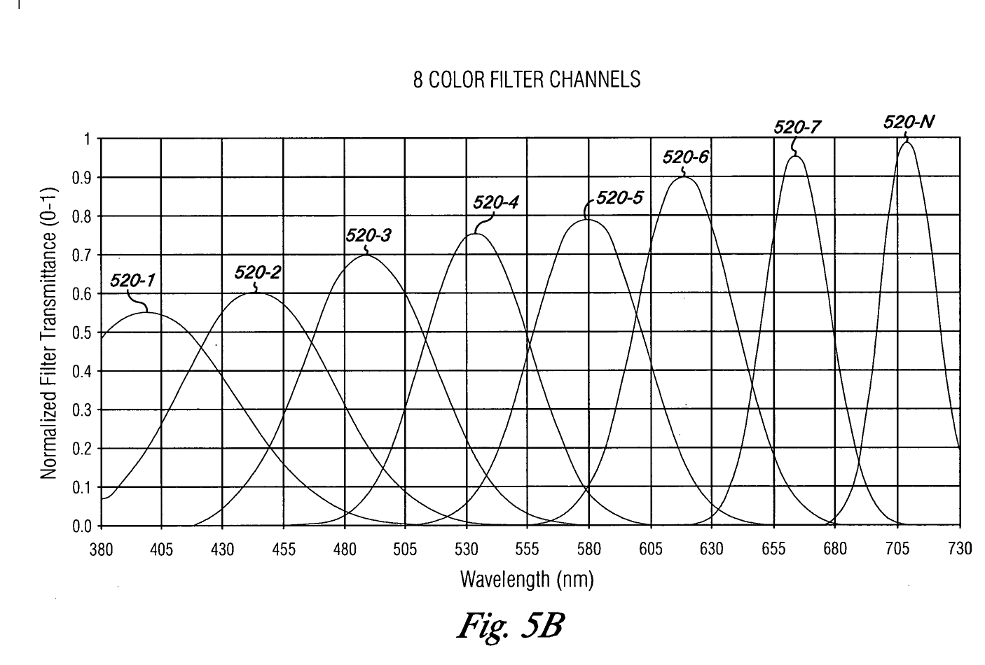

FIG. 5A illustrates a representation of a set of example light transmission curves for an eight color filter array. The graph illustrated in FIG. 5A shows a representation of relative intensity of light transmittance through various embodiments of color filters on the vertical axis within a spectrum of light wavelengths measured in nanometers (nm) on the horizontal axis.

Each transmission curve can be referred to by the wavelength value of its peak or maximum transmittance value. Each transmission curve also has an associated width. The width can be determined by the wavelengths where the transmittance values fall to some predetermined level (e.g., where the transmittance is 50% of the peak transmittance or falls below 10% without regard to the peak transmittance). For example, if a filter has its peak transmittance value at a wavelength equal to 550 nm and the transmittance falls to 0.1 at wavelengths of 530 nm and 580 nm, the filter can be referred to as the ‘550 nm’ or green filter with a 0.1 bandwidth of 50 nm (580-530 nm).

In the 0.0 to 1.0 scale on the vertical axis of the graph, a low value can indicate relatively little transmittance of a particular color wavelength through a particular color filter, whereas a value closer to 1.0 can indicate relatively higher transmittance of a particular color wavelength through a particular color filter. The wavelength spectrum shown on the horizontal axis of the graph can represent a color spectrum visible to the human eye, which can range from around 380 nm through around 730 nm.

In the graph, transmittance intensity curves for eight color filters are shown as measured across the visible color spectrum. The eight color filters were formed using one or more sets of materials with differing color spectral characteristics. As discussed above, this could also be accomplished by changing the thickness of the same type of material, thereby creating different color spectral characteristics.

Combination of at least two colors such as two or more selected from R1 (a material having a first set of red color characteristics), G1, B1, R2 (a material having a second set of red color characteristics), G2, B2 and/or other materials having different color spectrum characteristics, can result in forming a color filter that transits a peak intensity of a wavelength that can differ from peak wavelengths transited by color filters such as those that are identified as transiting B1 (520-1), B2 (520-2), G1 (520-3), G2 (520-4), R1 (520-5, and R2 (520-N). In some embodiments, combining at least two materials identified with forming color filters, such as two or more selected from R1, G1, B1, R2, G2, B2, can assist in forming a CFA that transits peak intensities of wavelengths spaced across a visible color spectrum.

As illustrated in the graph of FIG. 5A, a number of curves are shown 520-1, 520-2, 520-3, 520-4, 520-5 . . . 520-N that, by way of example and not by way of limitation, demonstrate transmittance profiles of eight different color filters formed using sets of materials that transit R1, G1, B1, R2, G2, B2 peak color intensities when used individually.

Achieving particular ratios of materials contributing to particular colors can be performed by, in some embodiments, using two layers of B color filters to one layer of G color filter, for example, or by, in some embodiments, mixing double the concentration of a material used in a B color filter with a concentration regularly used in a G color filter, for example. Using thicker layers of color filters and/or increased concentrations of materials for one color relative to another color can, in some embodiments, result in a peak intensity wavelength to be shifted relative to those achieved using the individual materials and/or equal combinations of the two. As discussed above and as illustrated in the graph of FIG. 5A, in some embodiments, greater or lesser concentrations of a color can be used.

For instance, increasing the thickness of a color filter, and/or increasing the concentration of materials used to form the color filter, can, in some embodiments, result in decreasing the intensity of light transited by the color filter, including the peak transmittance wavelength. Such peak intensity differences can, in some embodiments, be compensated for using processing circuitry, if it is not useful.

As illustrated by the graph in FIG. 5A, a number of materials each having a different color spectral characteristic can be used to form an array of color filters transiting at least five portions of a visible color spectrum. Various combinations of color filters thus formed can provide a peak intensity of light within one of the portions of the color spectrum to the circuitry for sensing.

In various embodiments, appropriate combinations of materials can enable selecting color filters such that the peaks of the portions can be spaced at substantially regular intervals across the visible color spectrum. Using various embodiments described in the present disclosure, a color measuring apparatus can have color channel spacing that can be determined by spacing of a peak intensity of light transiting each filter associated with each channel through a number of sensing circuits. In some embodiments, the overlap of the color channels can be used to more specifically identify a color sensed by using information collected via more than one of the color channels. In this manner, the combination of color channel information can provide more accurate information and can reduce or eliminate metamerism.

FIG. 5B illustrates representation of another set of example light transmission curves for an eight color filter array. As with the graph of FIG. 5A, the graph illustrated in FIG. 5B illustrates a representation of relative intensity of light transmittance through various embodiments of color filters on the vertical axis within a spectrum of light wavelengths measured in nanometers (nm) on the horizontal axis.

In this representation, each transmission curve can be referred to by the wavelength value of its peak or maximum transmittance value. Each transmission curve also has an associated width.

As with the representation of FIG. 5A, the width can be determined by the wavelengths where the transmittance values fall to some predetermined level (e.g., where the transmittance is 50% of the peak transmittance or falls below 10% without regard to the peak transmittance). For example, if a filter has its peak transmittance value at a wavelength equal to 550 nm and the transmittance falls to 0.1 at wavelengths of 530 nm and 580 nm, the filter can be referred to as the ‘550 nm’ or green filter with a 0.1 bandwidth of 50 nm (580-530 nm).

As in the representation of FIG. 5A, in the 0.0 to 1.0 scale on the vertical axis of the graph, a low value can indicate relatively little transmittance of a particular color wavelength through a particular color filter, whereas a value closer to 1.0 can indicate relatively higher transmittance of a particular color wavelength through a particular color filter. The wavelength spectrum shown on the horizontal axis of the graph can represent a color spectrum visible to the human eye, which can range from around 380 nm through around 730 nm.

Graphs, such as those shown in FIGS. 5A and 5B, can be used to determine a particular wavelength at which a color filter allows a peak transmittance intensity and its associated bandwidth. By measuring the transmittance of more than one color filter, a determination can be made of a separation distance(s) between the wavelengths of the peak transmittance intensities.

In the graph of FIG. 5B, transmittance intensity curves for eight color filters are shown as measured across the visible color spectrum. The eight color filters were formed using one or more sets of materials with differing color spectral characteristics.

In the representation of FIG. 5B, the intensities of the filters are also changed across the spectrum. This can be an added factor that can be used to better identify a color being measured. The changes in the position of the filters across the spectrum, their widths as represented on the graph, and their intensities could be accomplished by changing the thickness of the same type of material, thereby creating different color spectral characteristics, or by using different combinations of one or more materials, having the same or different thicknesses and/or densities.

For example, as discussed above with respect to the representation of FIG. 5A, achieving particular ratios of materials contributing to particular colors can be performed by, in some embodiments, using two layers of B color filters to one layer of G color filter, for example, or by, in some embodiments, mixing double the concentration of a material used in a B color filter with a concentration regularly used in a G color filter, for example. Using thicker layers of color filters and/or increased concentrations of materials for one color relative to another color can, in some embodiments, result in a peak intensity wavelength to be shifted relative to those achieved using the individual materials and/or equal combinations of the two.

As illustrated by the graph in FIG. 5B, a number of materials each having a different color spectral characteristic and one or more different intensities can be used to form an array of color filters transiting at least five portions of a visible color spectrum. Various combinations of color filters thus formed can provide a peak intensity of light within one of the portions of the color spectrum to the circuitry for sensing.

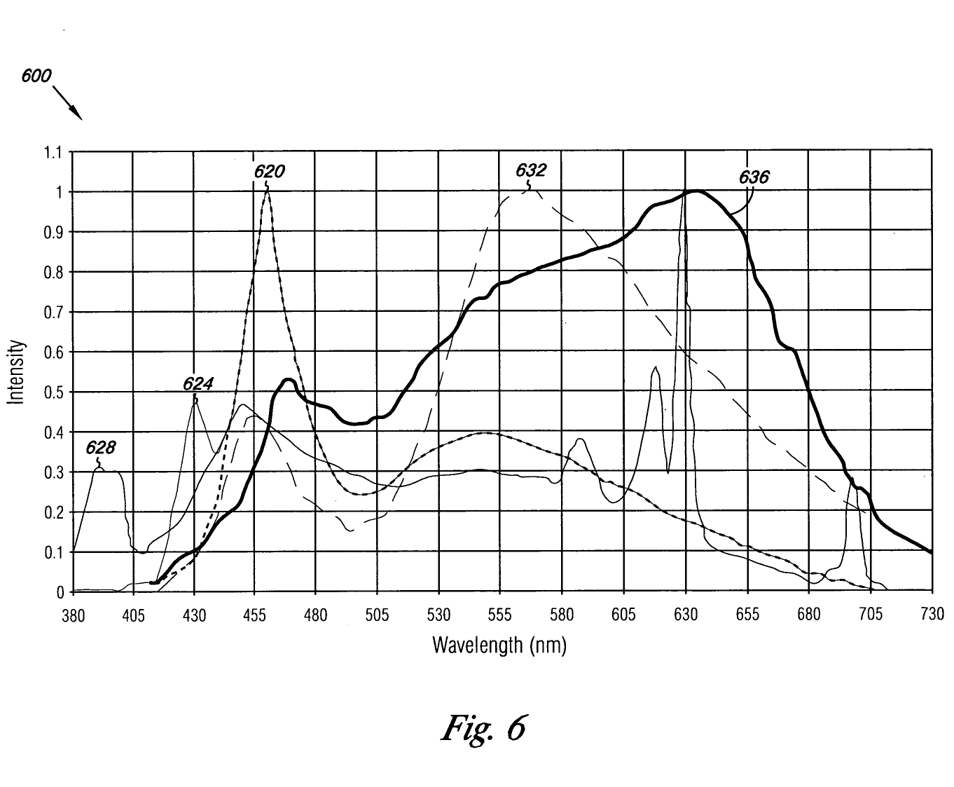

FIG. 6 illustrates a representation of light sources emitting light with differing intensities across a visible color spectrum according to an embodiment of the present disclosure. Suitable light sources can, for example, be gas discharge, incandescent, or LED-based, among others. The selection can be based upon a number of factors. For example, LED's are convenient since they can be easier to drive, less expensive, and/or cooler, than the above mentioned gas discharge and incandescent examples.

Embodiments of the present disclosure can utilize a number of light sources having different light emitting characteristics. In providing such light sources, the apparatus can be applied in a number of situations. For example, the apparatus can be designed with suitable light sources to provide color accuracy, measurement according to industry standards, measurement of special materials, among other functions.

The graph 600 illustrated in FIG. 6 shows a representation of relative intensity of light emitted by various embodiments of light-emitting diodes (LEDs), and combinations thereof, on the vertical axis within a spectrum of light wavelengths measured in nm on the horizontal axis.

In the 0.0 to 1.0 scale on the vertical axis of graph 600, a low value can indicate relatively little emission of a particular color wavelength by a particular LED, or a particular combination of LEDs, whereas a value closer to 1.0 can indicate relatively higher emission of a particular color wavelength by a particular LED, or a particular combination of LEDs. The wavelength spectrum shown on the horizontal axis of graph 600 can represent a color spectrum visible to the human eye, which can range from around 380 nm through around 730 nm.

A graph such as that shown in FIG. 6 can be used to determine particular wavelengths at which a particular LED, a particular combination of LEDs, and/or other light sources, emit one or more peaks and valleys of intensity at wavelengths throughout a color spectrum, along with relative emission intensities in between. In graph 600, emission intensity curves for five particular LEDs, or particular combinations of LEDs, are shown as measured across the visible color spectrum.

As further described below, a particular LED that emits light in a defined wavelength range can be combined with a particular phosphor(s) that can be excited by the light emitted by the LED and can emit light having a range of longer light wavelengths to broaden the color spectrum of the light emitted by the LED light source. The five LED light sources shown in graph 600 were formed using a number of individual LEDs with a specific phosphor(s), or combinations thereof.

Illuminating an object to enable potential reflection of light wavelengths ranging across a visible color spectrum, and thereby enabling adequate measurement of the object's colors, can be achieved using light sources that emit high intensity of light, with relative uniformity of intensity, across the spectrum to be measured, for example, from around 380 nm through around 730 nm, in some embodiments. Some spectrophotometers can use a light source such as a tungsten lamp or xenon flash that can provide a broad range of illumination. However, such apparatuses are often expensive. A less expensive spectrophotometer, or a calorimeter, can use a “white light LED”, as described below, among other light sources.

The graph 600 illustrated in FIG. 6 shows a range of light emission intensities that can be produced by an embodiment of a “white light” LED. A white light LED can include a LED that emits blue light wavelengths combined with a yellow phosphor that can become excited by the blue light wavelengths to emit a range of longer wavelengths of light.

A curve 620 illustrating intensities of light in a visible spectrum that can be produced by an embodiment of a white light LED is shown in graph 600. The curve 620 shows that a white light LED can emit light having high intensity (around 1.0) in a blue region of the color spectrum with more moderate intensities (from around 0.2 to around 0.4) up to the orange-red region of the color spectrum.

Notably, as shown in the curve 620 of graph 600, the white light LED embodiment can emit an intensity that drops from around 0.1 to around 0.0 at wavelengths shorter than around 430 nm. Because the human visual system (HVS) can perceive light wavelengths as short as 360-380 nm, illumination of an object with a white light LED that does not emit wavelengths that short, for reflection by the object, can introduce error in color measurements made by a color measurement apparatus.

Complying with an applicable color imaging standard (e.g., an ISO Proofing Standard) can include illuminating an object with a light source that substantially covers the color spectrum perceivable by the HVS. A high-brightness print medium can have “brighteners” to enhance the intensity of reflected blue light. Among possible influences on printed colors, a brightener can increase brightness so that a print medium appears whiter than it would otherwise appear. Such high-brightness print medium can utilize short wavelength light to excite the brighteners. The ISO Proofing Standard specifies that brighteners are to be excited, which can be done with light sources that emit wavelengths in the 380-420 nm range.

As illustrated in graph 600 of FIG. 6, curve 624 shows that an embodiment of an “ultra-blue” LED can emit light with a peak wavelength around 430 nm. The embodiment of the ultra-blue LED used for curve 624 can emit light at around 420 nm with an intensity of around 0.2, which is notably higher than the intensity emitted by the white light LED at 420 nm shown in curve 620.

To improve accuracy of color measurement and better comply with applicable imaging standards (e.g., the ISO Proofing Standard), a light source can be used for illuminating an object to be measured that includes an array of at least two LEDs each having different color characteristics, where a combination of emitted light substantially covers a visible color spectrum. For example, graph 600 of FIG. 6 illustrates an embodiment of combining the ultra-blue LED with the white light LED by showing the light emission curve 624 of the ultra-blue LED merging with the light emission curve 620 of the white light LED.

To more strongly excite brighteners in a print medium (e.g., to comply with the ISO Proofing Standard), a light source can be used having higher intensity emissions in wavelengths closer to 380 nm. For example, graph 600 of FIG. 6 illustrates an emission curve 628 for an embodiment of a “super-white” LED.

The embodiment of the super-white LED illustrated in graph 600 can be formed, for example, using a violet LED combined with three phosphors. The curve 628 for the super-white LED shows an emission intensity having a broad peak (around 0.3) from around 390-400 nm. In some embodiments, combining the super-white LED with the ultra-blue LED and/or the white light LED can provide relative uniformity in the shorter wavelengths of the visible spectrum.

However, as shown in curve 628, at longer wavelengths (e.g., around 615-630 nm and around 700 nm) the super-white LED embodiment can have notable spikes in emission intensity. Hence, in some embodiments, accuracy of color measurement can decrease when using a super-white LED. Consequently, having an ability to selectively turn off and on a first type of a LED used in combination with a second type of a LED can be advantageous.

Graph 600 of FIG. 6 illustrates an emission curve 632 for a first embodiment of a “warm-white” LED. The warm-white LED can be formed using a blue LED combined with a particular combination of yellow and red phosphors. The curve 632 for the warm-white LED shows an emission intensity reaching a peak (at around 1.0) at a wavelength around 560-570 nm in the green portion of the color spectrum.

From the peak, the curve 632 shows intensities that decline gradually as wavelengths reach the red and far-red portions of the color spectrum (e.g., the intensity reaches around 0.2 at around 705 nm). In some embodiments, combining the warm-white LED with the super-white LED, the ultra-blue LED, and/or the white light LED can provide increased intensity and/or relative uniformity in the longer wavelengths of the visible spectrum.

Graph 600 of FIG. 6 illustrates an emission curve 636 for a second embodiment of a “warm-white” LED. The second embodiment of the warm-white LED can be formed using a blue LED combined with a particular combination of yellow and red phosphors that differ from the phosphors used in the first embodiment of the warm-white LED.

The curve 636 for the warm-white LED shows an emission intensity reaching a peak (at around 1.0) at a wavelength around 630-640 nm in the red portion of the color spectrum. From the peak, the curve 636 shows intensities that decline more sharply than the 632 curve as wavelengths reach the far-red portion of the color spectrum (e.g., where the intensity also reaches around 0.2 at around 705 nm).

In some embodiments, combining the second embodiment of the warm-white LED with the first embodiment of the warm-white LED, the super-white LED, the ultra-blue LED, and/or the white light LED can provide increased intensity and/or relative uniformity in the longer wavelengths of the visible spectrum. Hence, an illumination system for a color measuring apparatus can include a number of embodiments of LEDs and/or other light sources, each of which can be turned on and off independently, or in programmed combinations, to improve color measurement and/or to comply with a particular imaging standard and/or to match interests of a particular user.

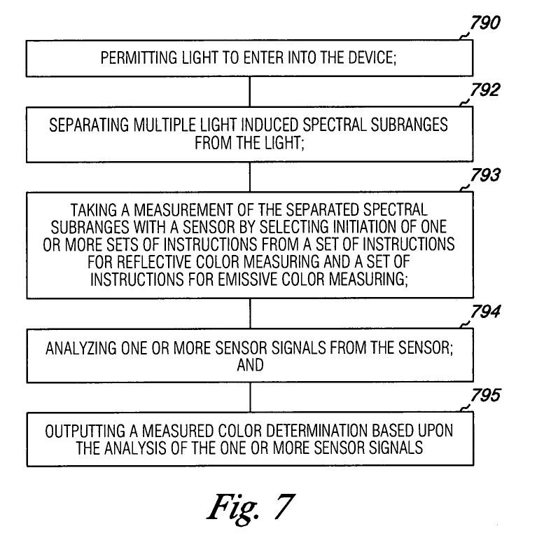

FIG. 7 is a block diagram illustrating a method of measuring color according to an embodiment of the present disclosure. Unless explicitly stated, the method embodiments described herein are not constrained to a particular order or sequence. Additionally, some of the described method embodiments, or elements thereof, can occur or be performed at the same, or at least substantially the same, point in time.

The embodiments described herein can be performed using logic, software, hardware, application modules, or combinations of these elements, and the like, to perform the operations described herein. Embodiments as described herein are not limited to any particular operating environment or to software written in a particular programming language. In various embodiments, the elements just described can be resident on the systems, and/or apparatuses shown herein, or otherwise.

Logic suitable for performing embodiments of the present disclosure can be resident in one or more apparatuses and/or locations. Processing modules used to execute operations described herein can include one or more individual modules that perform a plurality of functions, separate modules connected together, and/or independent modules.

The embodiment illustrated in FIG. 7 includes a method of measuring color, including permitting light to enter into the device, at block 790. In such embodiments, the light can be either refelective or emissive light.

The method embodiment of FIG. 7 also includes separating multiple light induced spectral subranges from the light, at block 792. In block 793, the method includes taking a measurement of the separated spectral subranges with a sensor by selecting initation of one or more sets of instructions from a set of instructions for reflective color measuring and a set of instructions for emissive color measuring.

The method of FIG. 7 includes analyzing one or more sensor signals from the sensor, at block 794. The method also includes outputting a measured color determination based upon the analysis of the one or more sensor signals, at block 795.

In some embodiments, a method can include taking a measurement with the internal illuminant in an off state and analyzing the measurement to determine if there is an amount of light energy over a threshold amount. Embodiments can also include taking a first measurement with the internal illuminant in a first state, taking a second measurement with the internal illuminant in a second state, and analyzing the first and second measurements to determine if there is a difference between amounts of light energy of the first and second measurements that is over a threshold amount. For example, the first state can be an off state and the second state can be an on state, or in some embodiments, the first state can be a high state and the second state can be a low state.

In some embodiments, if the analysis of the first and second measurements to determine if there is a difference between amounts of light energy of the first and second measurements that is over a threshold amount indicates that the difference is over the threshold, then a target can be determined to be reflective. Accordingly, in some embodiments, if the analysis of the first and second measurements to determine if there is a difference between amounts of light energy of the first and second measurements that is over a threshold amount indicates that the difference is not over the threshold, then a target can be determined to be emissive. Other such threshold based determinations can be made based upon the sensor data and/or calculations thereof, such as the difference.

Although specific embodiments have been illustrated and described herein, those of ordinary skill in the art will appreciate that an arrangement calculated to achieve the same techniques can be substituted for the specific embodiments shown. This disclosure is intended to cover all adaptations or variations of various embodiments of the present disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure have to use more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A color measuring apparatus, comprising:
a color filter array having a number of filters thereon, where the number of filters transit light to a number of sensors of a sensing circuit in a portable color measuring apparatus;
a memory having a number of sets of instructions executable by a processing circuit; and
the memory including instructions to:
select initiation of one or more sets of instructions for reflective color measuring and a set of instructions for emissive color measuring; and
where one of the sets of reflective color measuring and emissive color measuring instructions utilize a number of specialized components that is not utilized by the other set of instructions.

2. The color measuring apparatus of claim 1, where the memory includes instructions to determine whether a measurement is to be taken utilizing the reflective or emissive color measuring instructions based upon data from one or more sensors.

3. The color measuring apparatus of claim 1, where the memory includes instructions to determine whether sensor data taken from one or more sensors is reflective or emissive color data.

4. The color measuring apparatus of claim 1, where the memory includes instructions to determine whether sensor data was taken utilizing the reflective or emissive color measuring instructions.

5. The color measuring apparatus of claim 1, where the memory includes instructions to take a first measurement with an internal illuminant in an on state, and to switch the illuminant to an off state to take a second measurement.

6. The color measuring apparatus of claim 5, where the apparatus includes an operator interface where an operator may select the first or second measurement.

7. The color measuring apparatus of claim 5, where the apparatus includes a set of instructions to indicate to the operator a type of measurement that one or more of the first or second measurements is.

8. The color measuring apparatus of claim 5, where the apparatus includes an orientation sensor and instructions to interpret orientation sensor data to determine whether a target is emissive or reflective.

9. The color measuring apparatus of claim 1, where the apparatus includes an orientation sensor and instructions to interpret orientation sensor data to determine a type of measurement that is to be performed by the apparatus.

10. A portable color measuring system, comprising:
a color filter array having a number of filters thereon, where the number of filters transit light to a number of sensors of a sensing circuit in a portable color measuring apparatus;
a sensing means for sensing whether a target to be measured is a reflective or emissive light source; and
a processing circuit for processing instructions to:
interpret data from the sensing mechanism;
select initiation of a set of instructions for reflective color measuring or a set of instructions for emissive color measuring based upon the interpretation of the data; and
where one of the sets of reflective color measuring or emissive color measuring instructions utilize a number of specialized components that is not utilized by the other set of instructions.

11. The system of claim 10, where the specialized components utilized by the reflective color measuring instructions includes a light-emitting diode for illumination of an object to be measured.

12. The system of claim 11, where the specialized components utilized by the reflective color measuring instructions includes at least two light-emitting diodes each having different color characteristics, where a combination of emitted light substantially covers a visible color spectrum.

13. The system of claim 10, where the system includes means of communicating to a remote location using a wireless connection.

14. The system of claim 10, where the portable color measuring apparatus includes:
a means to record the light color spectrum measurement and the information associated with the object being measured on a storage medium that is removable;
a spot locator;
a strip guide;
a cathode ray tube holder;
a liquid crystal display holder; and
at least one calibration reference sample, where a group of calibration reference samples includes a white sample, a black sample, and a gray sample.

15. The system of claim 10, where the portable color measuring apparatus includes a color calibration component.

16. The system of claim 10, where the portable color measuring apparatus includes a color calibration component having multiple reference components.

17. A method of measuring color, comprising:
permitting light to enter into the device;
separating multiple light induced spectral subranges from the light;
taking a measurement of the separated spectral subranges with a sensor by selecting initiation of one or more sets of instructions from a set of instructions for reflective color measuring and a set of instructions for emissive color measuring;
analyzing one or more sensor signals from the sensor; and
outputting a measured color determination based upon the analysis of the one or more sensor signals.

18. The method of claim 17, where taking a measurement includes taking a measurement with the internal illuminant in an off state; and
where analyzing one or more sensor signals from the sensor includes analyzing the measurement to determine if there is an amount of light energy over a threshold amount.

19. The method of claim 17, where taking a measurement includes taking a first measurement with the internal illuminant in a first state;
taking a second measurement with the internal illuminant in a second state; and
where analyzing one or more sensor signals from the sensor includes analyzing the first and second measurements to determine if there is a difference between amounts of light energy of the first and second measurements that is over a threshold amount.

20. The method of claim 19, where the first state is an off state and the second state is an on state.

21. The method of claim 19, where the first state is a high state and the second state is a low state.

22. The method of claim 19, where if the analysis of the first and second measurements to determine if there is a difference between amounts of light energy of the first and second measurements that is over a threshold amount indicates that the difference is over the threshold, then a target is determined to be reflective.
